(19) United States
(12) Patent Application Publication
(10) Pub. No.: US 2012/0091296 A1
(43) Pub. Date: Apr. 19, 2012

(54) Adjustable Supporting Apparatus of Object Holder

(76) Inventor: Tsung-Ying Lee, Tainan (TW)

(21) Appl. No.: 12/903,215

(22) Filed: Oct. 13, 2010

(51) Int. Cl. F16M 11/04

(52) U.S. Cl. 248/122.1

(57) ABSTRACT

An adjustable supporting apparatus of an object holder includes a body including an upper seat mounted on an upper end thereof for receiving an object, and a plurality of support elements, wherein each of the support elements has one end axially connected on the upper seat of the body by means of an axial rotating structure and another end having an abutting portion formed thereon to rotate axially by means of the axial rotating structure and to abut against the object. Hence each of the support elements is capable of being rotated to adjust a desired holding range and height with respect to the size of the object to enhance utility.

### BACKGROUND OF THE PRESENT INVENTION

1. Field of Invention

The present invention relates to an adjustable supporting apparatus of an object holder which is capable of being rotated to adjust a desired holding range and height with respect to the size of the object to be supported for better convenient and decorative purposes.

2. Description of Related Arts

A conventional holder is generally used by consumers to hold various objects, such as cups, dishes, and bowls, etc. Referring to FIG. 1, an object holder 10 includes a body 11 having a peripheral frame 12 to hold a conical object 20, wherein a constant inner diameter D of the peripheral frame 12 is not adjustable. Therefore, as desiring to hold the object 20 on the peripheral frame 12, a first largest outer diameter d1 of a top end of the object 20 must be larger than the inner diameter D of the peripheral frame 12 and a first smallest outer diameter d2 of a bottom end of the peripheral frame 12 must be less than the inner diameter D of the peripheral frame 12, so that the object 20 can be inserted into the peripheral frame 12 from the bottom end of the peripheral frame 12. Moreover, the first largest outer diameter d1 and the first smallest outer diameter d2 of the object 20 are made in a suitable size so that the peripheral frame 12 is capable of abutting against a central portion of a peripheral side of the object 20 in order to provide aesthetics appearance.

However, the inner diameter D of the peripheral frame 12 is also a non-adjustable fix dimension so that it is not able to be adjusted to extend its distance and to obtain preferable appearance. As shown in FIG. 2, the peripheral frame 12 is used to hold a conical object 21, wherein a second largest outer diameter d1′ of a top end of the conical object 21 is larger than the inner diameter D of the peripheral frame 12 and a second smallest outer diameter d2′ of a bottom end of the peripheral frame 12 is smaller than the inner diameter D of the peripheral frame 12. Although the conical object 21 allows to be held on the peripheral frame 12, the second largest outer diameter d1′ of the conical object 21 has only tiny difference from the inner diameter D of the peripheral frame 12. Therefore the peripheral frame 12 has to contact with the top end of the conical object 20 resulting in a poor appearance.

As illustrated in FIG. 3, the peripheral frame 12 is arranged to hold another conical object 22, wherein a third largest outer diameter d1″ of a top end of the conical object 22 is larger than the inner diameter D of the peripheral frame 12 and a third smallest outer diameter d2″ of a bottom end of the peripheral frame 12 is smaller than the inner diameter D of the peripheral frame 12. Even though the conical object 22 is allowed to be held in the peripheral frame 12, the third smallest outer diameter d2″ of the conical object 22 only has a tiny difference from the inner diameter D of the peripheral frame 12. Therefore, the peripheral frame 12 contacts with the bottom end of the conical object 22 resulting in a poor appearance.

Referring further to FIG. 4, the inner diameter of the peripheral frame 12 is a fix dimension that is non-adjustable. Accordingly, when the largest outer diameter of the object is smaller than the inner diameter D of the peripheral frame 12, the object is unable to be held on the peripheral frame 12. For example, the peripheral frame 12 serves to hold a cylindrical object 23 and an external diameter d3 of the cylindrical object 23 is smaller than the inner diameter D of the peripheral frame 12. After the cylindrical object 23 is inserted in the peripheral frame 12, it is unable to be held by the peripheral frame 12, thus limiting its holding range and shape.

The present invention has arisen to mitigate and/or obviate the afore-described disadvantages.

### SUMMARY OF THE PRESENT INVENTION

The primary object of the present invention is to provide an adjustable supporting apparatus of an object holder, which is capable of being rotated to adjust a desired holding range with respect to the size of the object to enhance its utility.

Another object of the present invention is to provide an adjustable supporting apparatus of an object holder, which is capable of being rotated to adjust a desired height according to the size of the object to enhance its utility.

In accordance with the present invention, an adjustable supporting apparatus for an object holder is provided, which comprises:
a body including an upper seat mounted on an upper end thereof for receiving an object; and
a plurality of support elements, each having one end axially connected to the upper seat of the body by using an axial rotating structure and another end having an abutting portion formed thereon to rotate axially by means of the axial rotating structure and to abut against the object.

### BRIEF DESCRIPTION OF THE DRAWINGS

FIG. 1 is a cross sectional view of a conventional object holder.

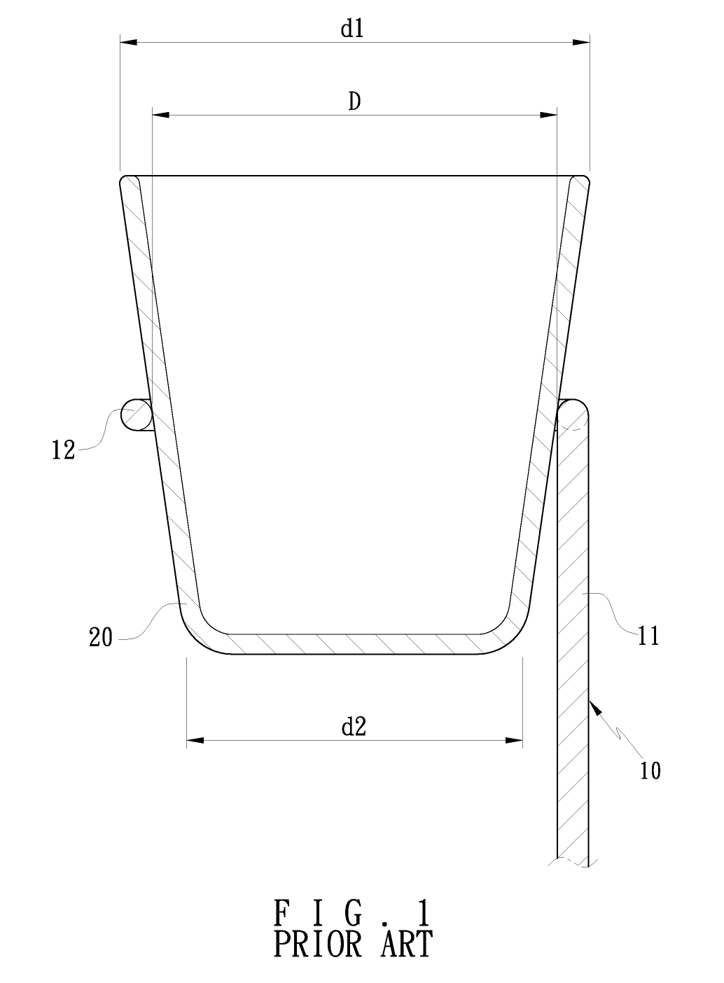

FIG. 2 is another cross sectional view of the conventional object holder.

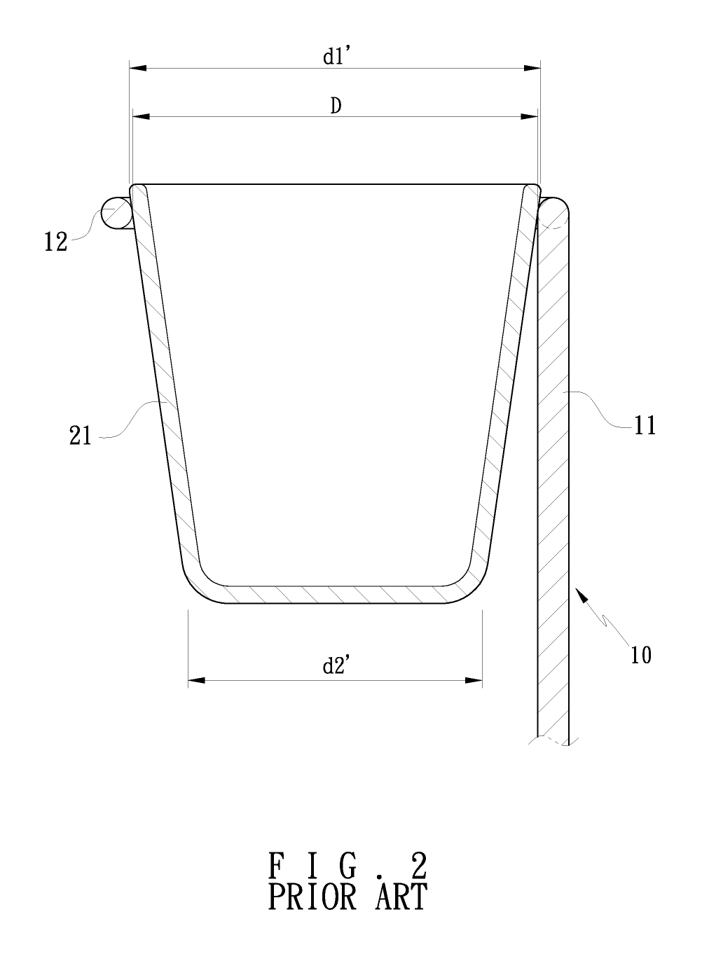

FIG. 3 is another cross sectional view of the conventional object holder.

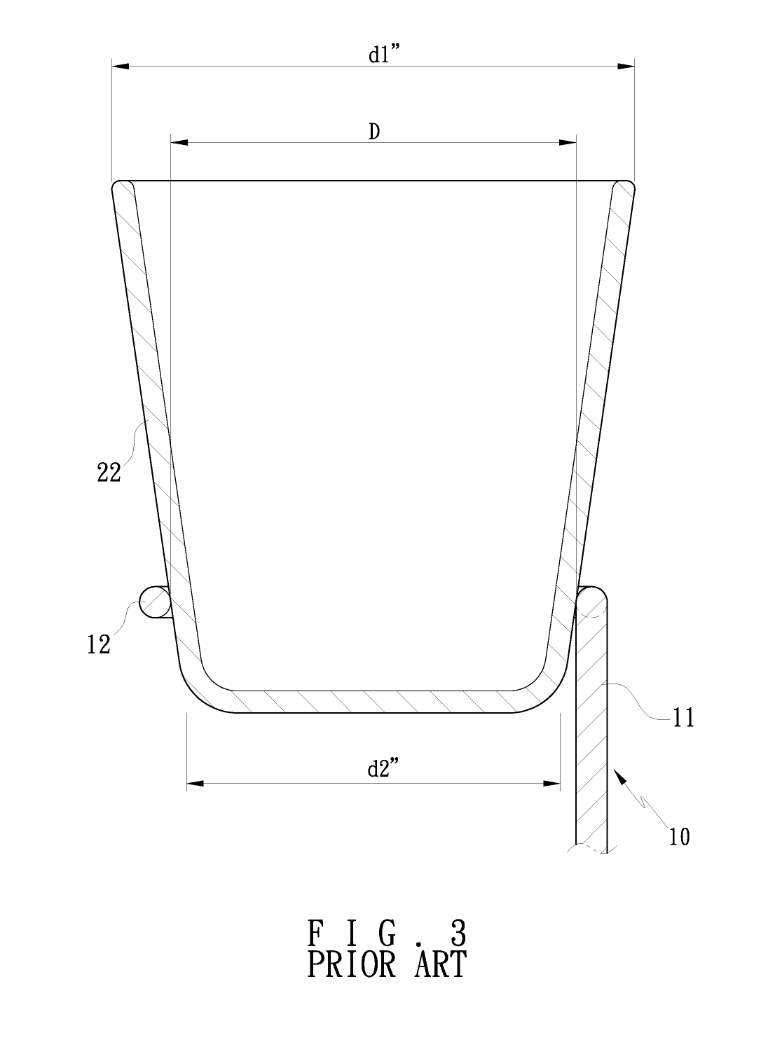

FIG. 4 is also another cross sectional view of the conventional object holder.

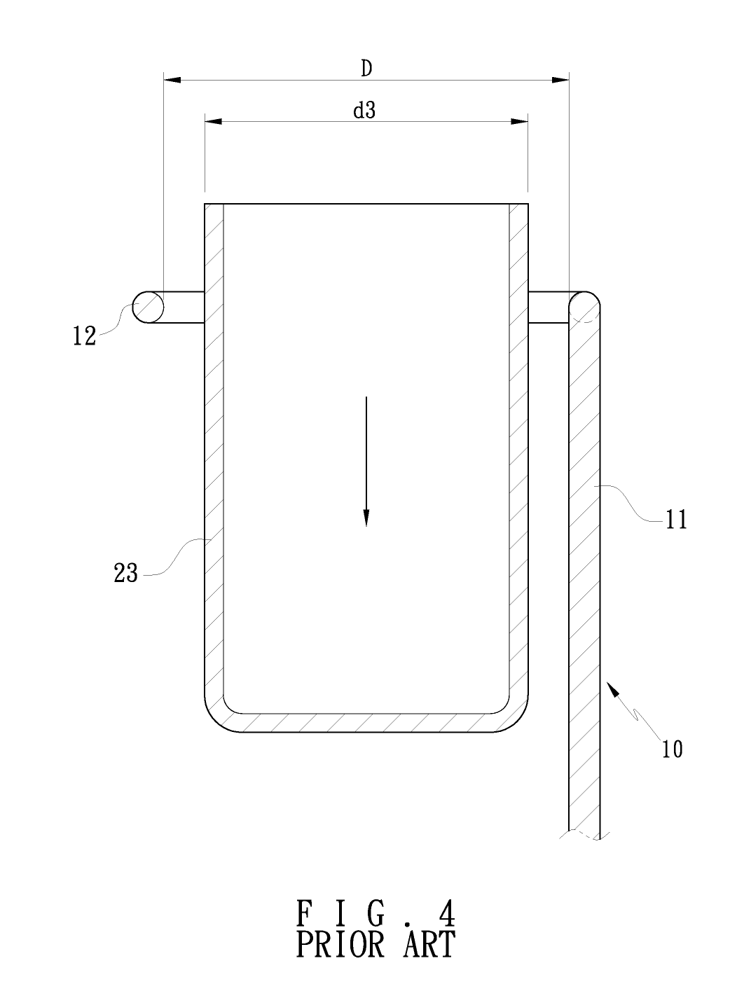

FIG. 5 is a perspective view showing the exploded components of an adjustable supporting apparatus for an object holder according to a first preferred embodiment of the present invention.

FIG. 6 is a perspective view showing the support elements of the adjustable supporting apparatus of the object holder according to the above first preferred embodiment of the present invention.

FIG. 7 is a perspective view showing the operation of the adjustable supporting apparatus for the object holder according to the above first preferred embodiment of the present invention.

FIG. 8 is a cross sectional view taken along the line A-A of FIG. 7.

FIG. 9 is another perspective view showing the operation of the adjustable supporting apparatus for the object holder according to the above first preferred embodiment of the present invention.

FIG. 10 is a cross sectional view taken along the line B-B of FIG. 9.

FIG. 11 is another perspective view showing the operation of the adjustable supporting apparatus for the object holder according to the above first preferred embodiment of the present invention.

FIG. 12 is a cross sectional view taken along the line C-C of FIG. 11.

FIG. 13 is a perspective view showing the exploded components of an adjustable supporting apparatus of an object holder according to a second preferred embodiment of the present invention.

FIG. 14 is a perspective view showing the support elements of the adjustable supporting apparatus of the object holder according to the above second preferred embodiment of the present invention.

FIG. 15 is a perspective view showing the operation of the adjustable supporting apparatus for the object holder according to the above second preferred embodiment of the present invention.

FIG. 16 is a cross sectional view taken along the line D-D of FIG. 15.

### DETAILED DESCRIPTION OF THE PREFERRED EMBODIMENT

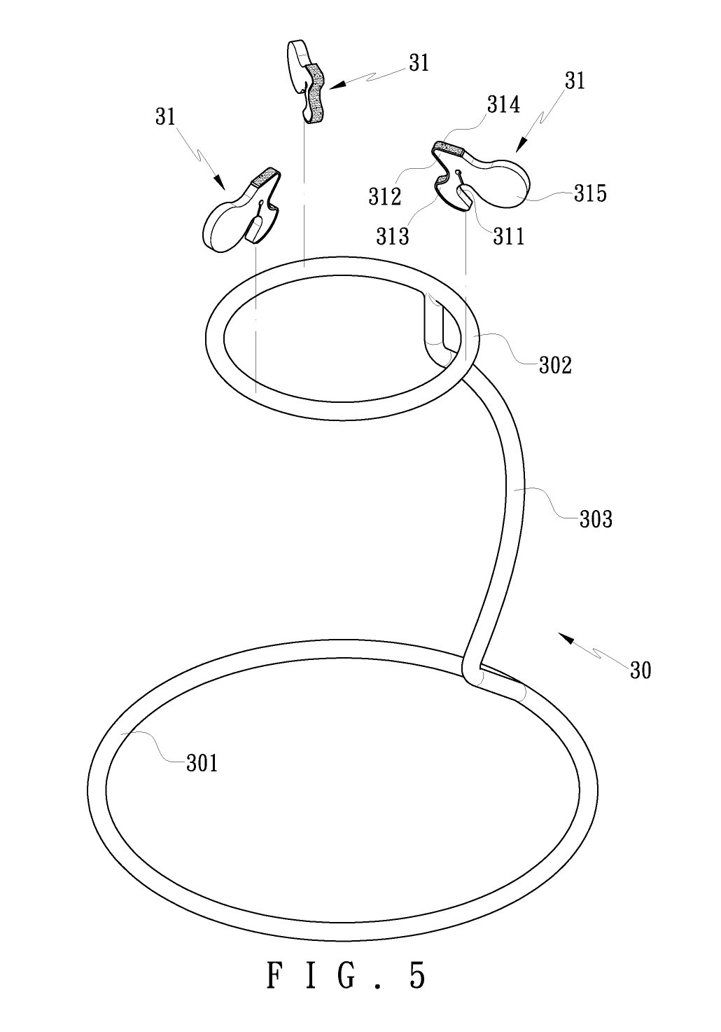

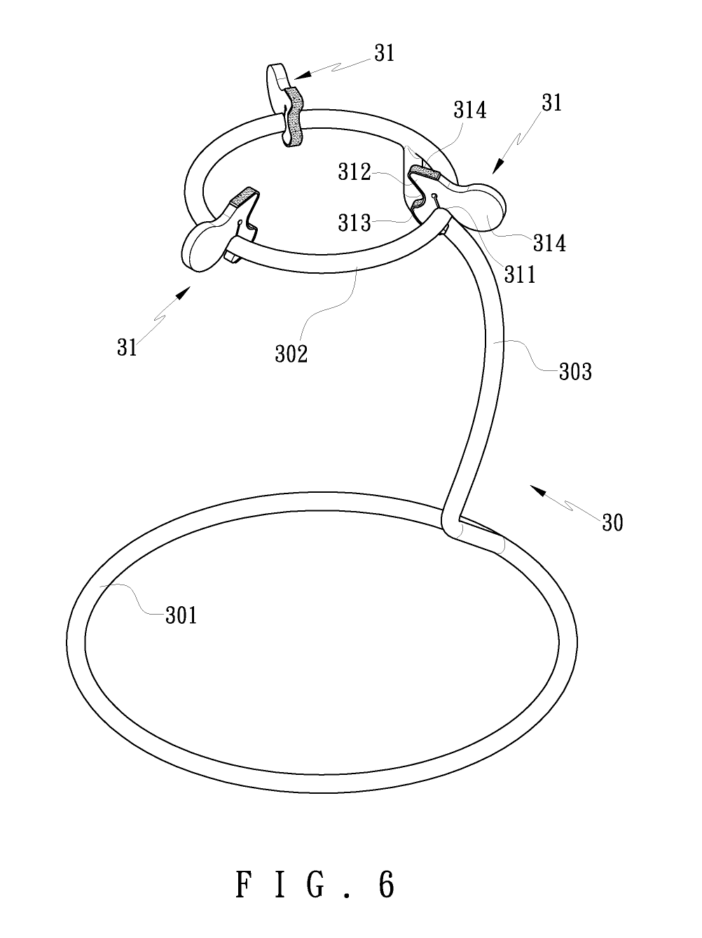

Referring to FIGS. 5 and 6, an adjustable supporting apparatus of an object holder in accordance with a first preferred embodiment of the present invention is illustrated, which comprises a body 30 and a plurality of support elements 31. The body 30 includes a bottom seat 301 disposed on a bottom end thereof, an upper seat 302 mounted on an upper end thereof, and a connecting post 303 connected between the bottom seat 301 and the upper seat 302, wherein the upper seat 302 is formed in a circular ring shape for receiving an object and the support elements 31 are arranged therearound.

An axial rotating structure is defined between one end of each support elements 31 and the upper seat 302 so that each of the support elements 31 can be rotated axially.

In this embodiment, the axial rotating structure includes an axial rotating portion 311 retained on the upper seat 302 so that the support element 31 is able to be rotated axially along the upper seat 302 by means of the axial rotating portion 311, wherein the axial rotating portion 311 is an open groove with an arcuate surface, wherein the arcuate surface has a flexible gap to be expanded and retracted. Each of the support elements 31 has an abutting portion formed on another end thereof to rotate axially by means of the axial rotating structure and to abut against the object.

In this embodiment, each of the support members 31 has a first abutting tab 312 disposed on another end thereof and a second abutting tab 313 located at one side of the first abutting tab 312 so that the first and the second abutting tabs 312, 313 are selected to hold the object according to the size of the object. Each of the first and the second abutting tabs 312, 313 includes an anti-slip member 314 attached thereon to increase friction between the first and the second abutting tabs 312, 313 and the object, wherein each of the support elements 31 further includes a holding projection 315 extending from one side thereof to be held by a user.

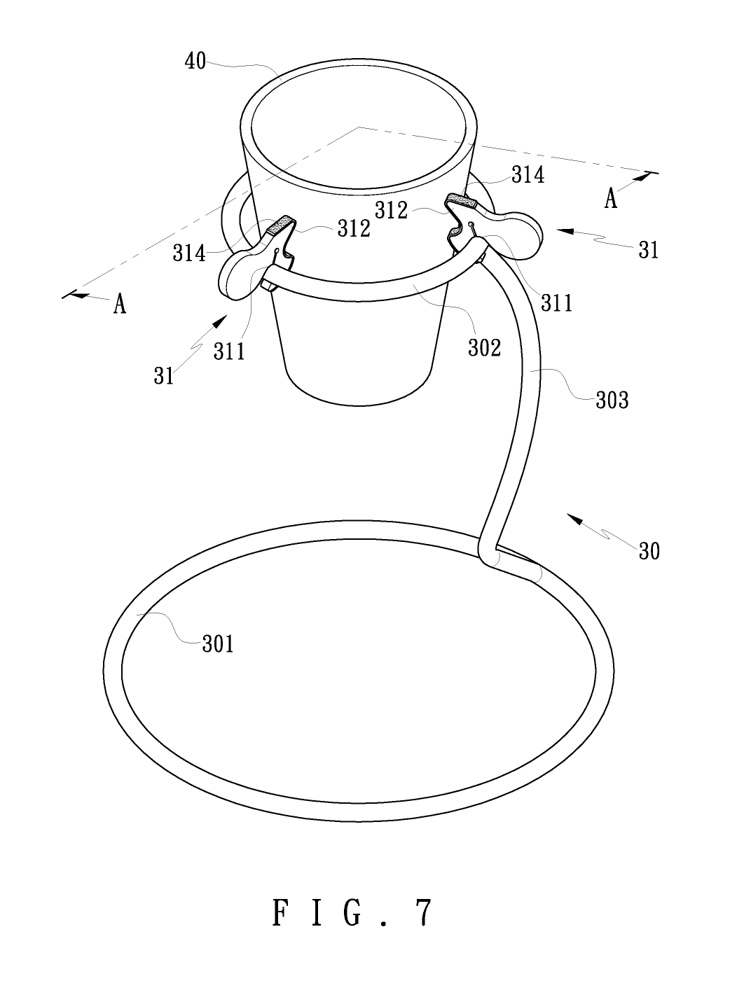

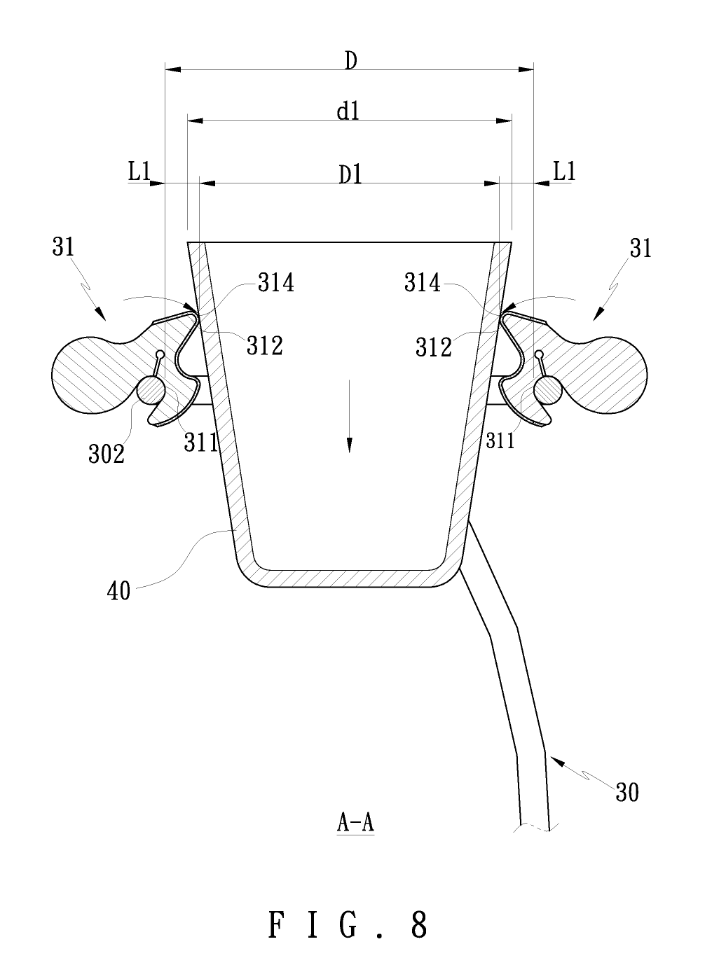

In operation, as shown in FIGS. 7 and 8, a first largest outer diameter d1 of a top end of the object 40 is smaller than a first inner diameter D of the upper seat 302 of the body 30, wherein the first abutting tabs 312 of the support elements 31 are axially rotated toward the upper seats 302 with respect to an outer diameter d1 of the object 40 so that the first abutting tabs 312 of the support elements 31 extend a first distance L1 toward the upper seat 302 to generate a first holding range, and a second inner diameter D1 of the first holding range is smaller than the first largest outer diameter d1 of the object 40. Hence, the first holding range between the first abutting tabs 312 of the support elements 31 enables the object 40 to be held in position, wherein a friction between the anti-slip members 314 and the object 40 and a gravity of the object 40 are applied to guide the first abutting tabs 312 to form a first inward rotating torque toward the upper seat 302. Then, the support elements 31 generate a second inward rotating torque toward the upper seat 302. Because the axial rotating portion 311 is limited by the upper seat 302, and the first abutting tab 312 is biased against the object 40, the support element 31 is not rotated toward the upper seat 302 anymore. In the contrast, the first abutting tab 312 generates a horizontal pushing force to support the object 40 stably.

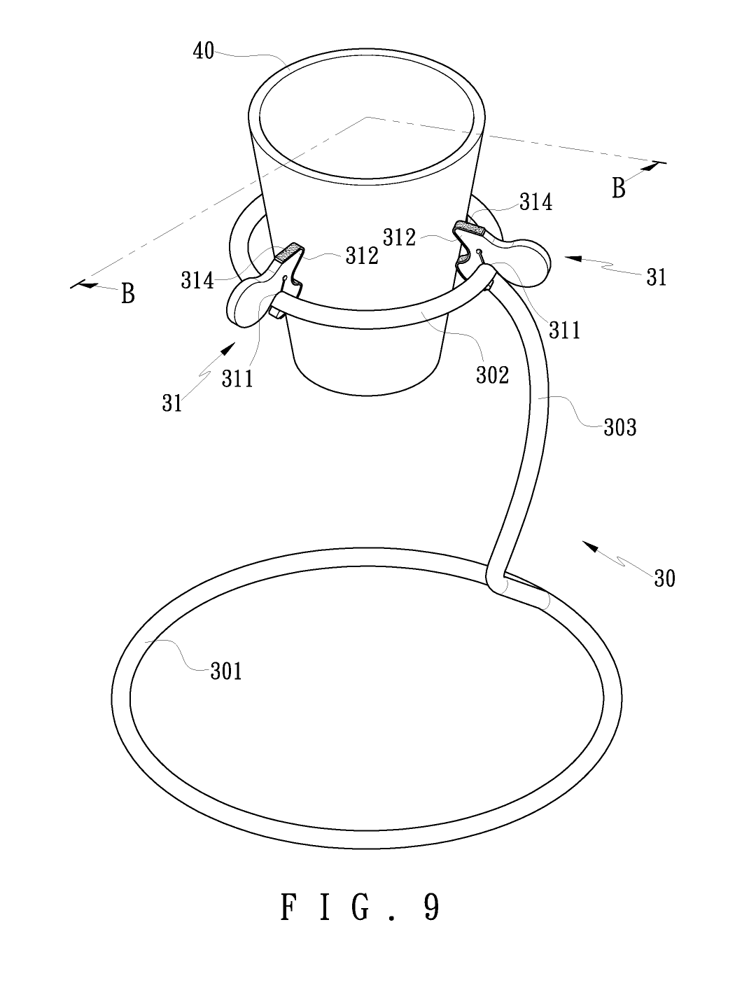

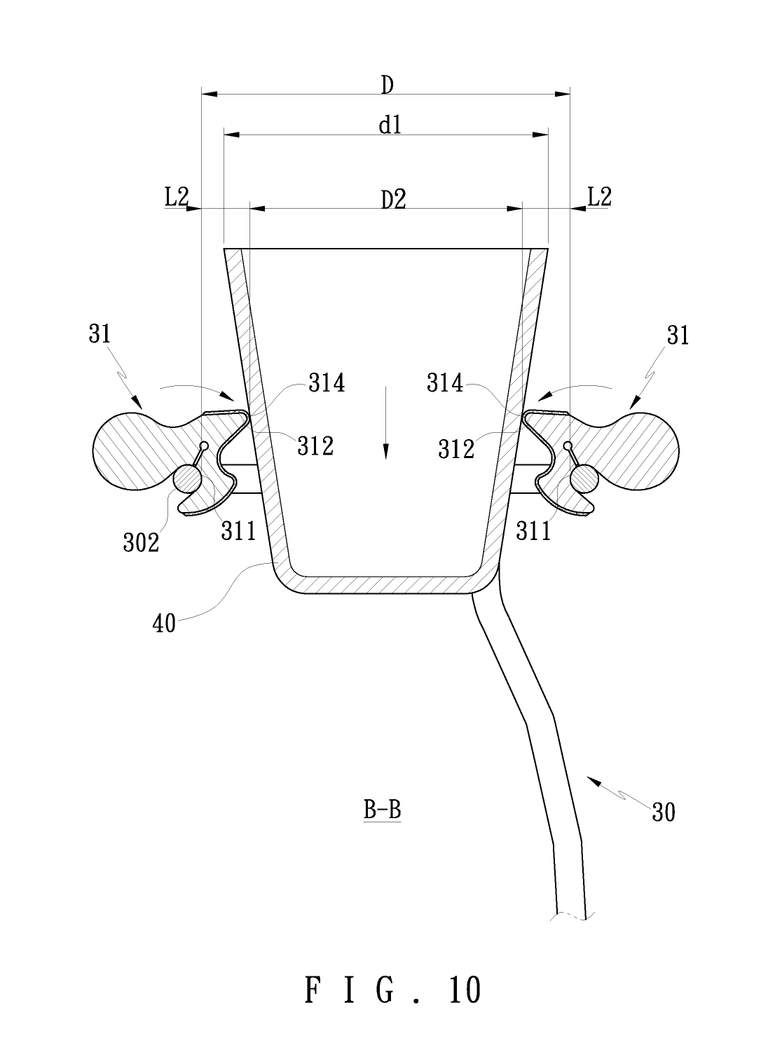

Referring further to FIGS. 9 and 10, as adjusting a height of the object 40, the first abutting tabs 312 of the support elements 31 are rotated axially toward the upper seat 302 so that the first abutting tabs 312 extend a second distance L2 toward the upper seat 302 to generate a third inner diameter D2 so that the object 40 can be held in position, e.g., the third inner diameter D2 between the first abutting tabs 312 decreases to raise a height to hold the object 40.

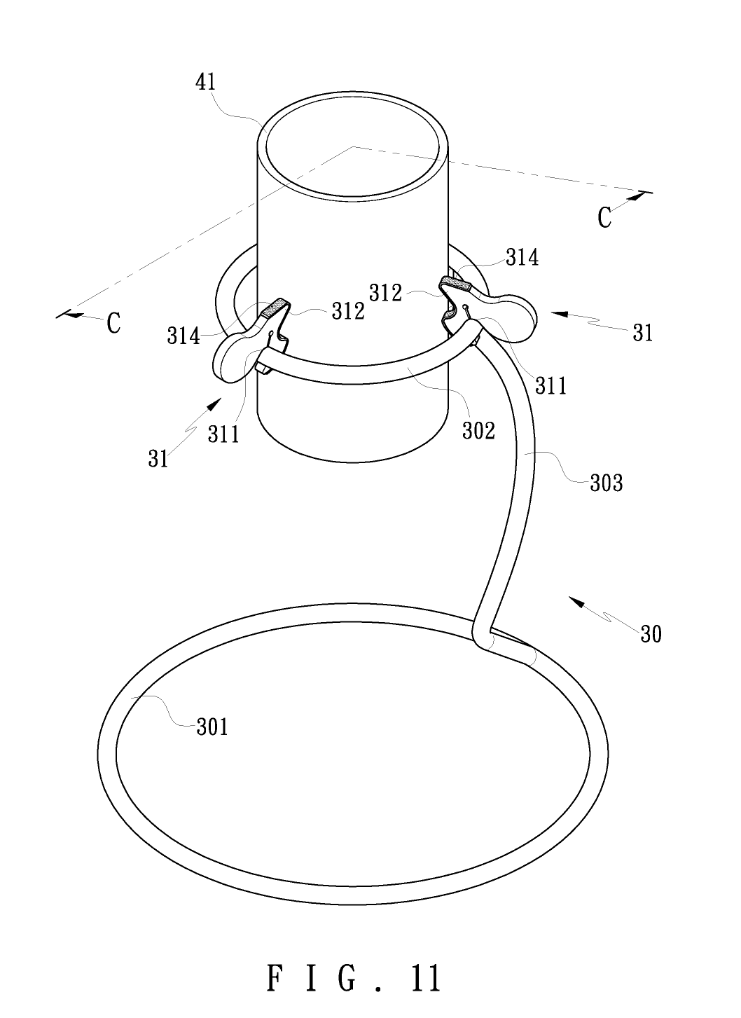

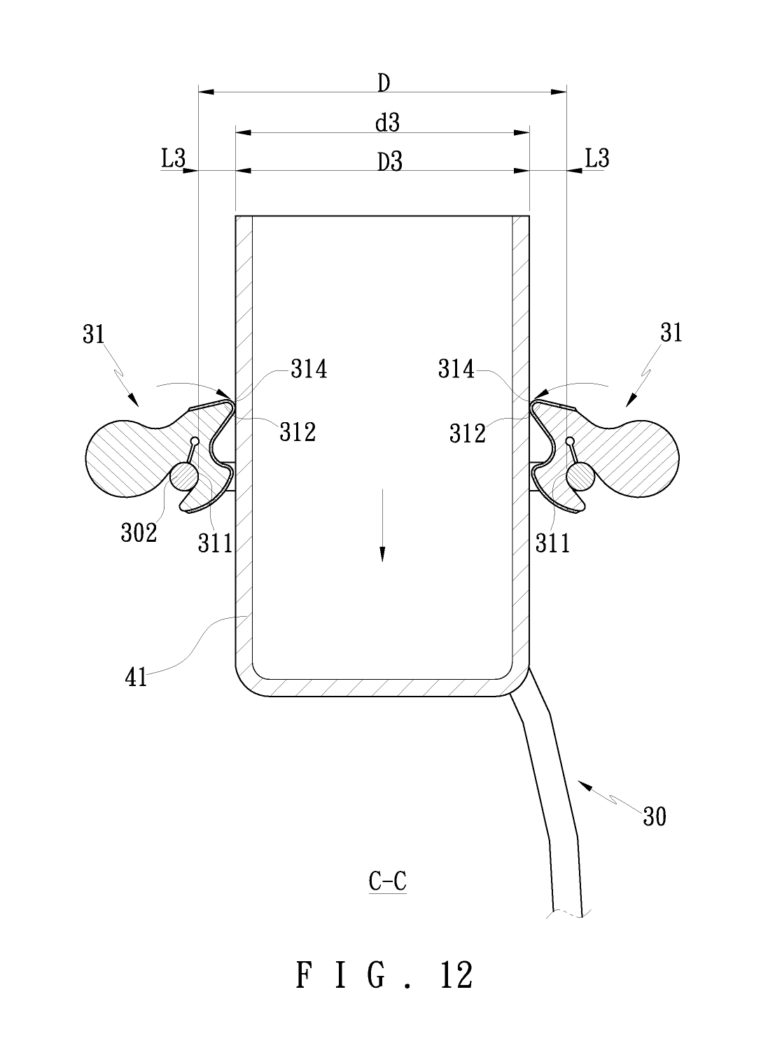

As illustrated in FIGS. 11 and 12, as holding a cylindrical object 41, due to a second largest outer diameter d3 of the cylindrical object 41 is smaller than the first inner diameter D of the upper seat 302 of the body 30, the first abutting tabs 312 of the support elements 31 are rotated toward the upper seat 302 of the body 30 according to the second largest outer diameter d3 of the cylindrical object 41, so that the first abutting tabs 312 of the support elements 31 extend a third distance L3 toward the upper seat 302 of the body 30 to generate a second holding range, wherein a fourth inner diameter D3 of the second holding range is smaller than the second largest outer diameter d3 of the cylindrical object 41. Accordingly, the second holding range between the first abutting tabs 312 of the support elements 31 allows the cylindrical object 41 to be held in position, and that when the first abutting tabs 312 of the support elements 31 hold the cylindrical object 41, a friction between the anti-slip members 314 and the cylindrical object 41 and a gravity of the cylindrical object 41 are served to guide the first abutting tabs 312 to form a third inward rotating torque toward the upper seat 302. Because the axial rotating portion 311 is limited by the upper seat 302, the support element 31 is not rotated toward the upper seat 302 anymore. In the contrast, the first abutting tab 312 generates a horizontal pushing force to support the cylindrical object 41 securely.

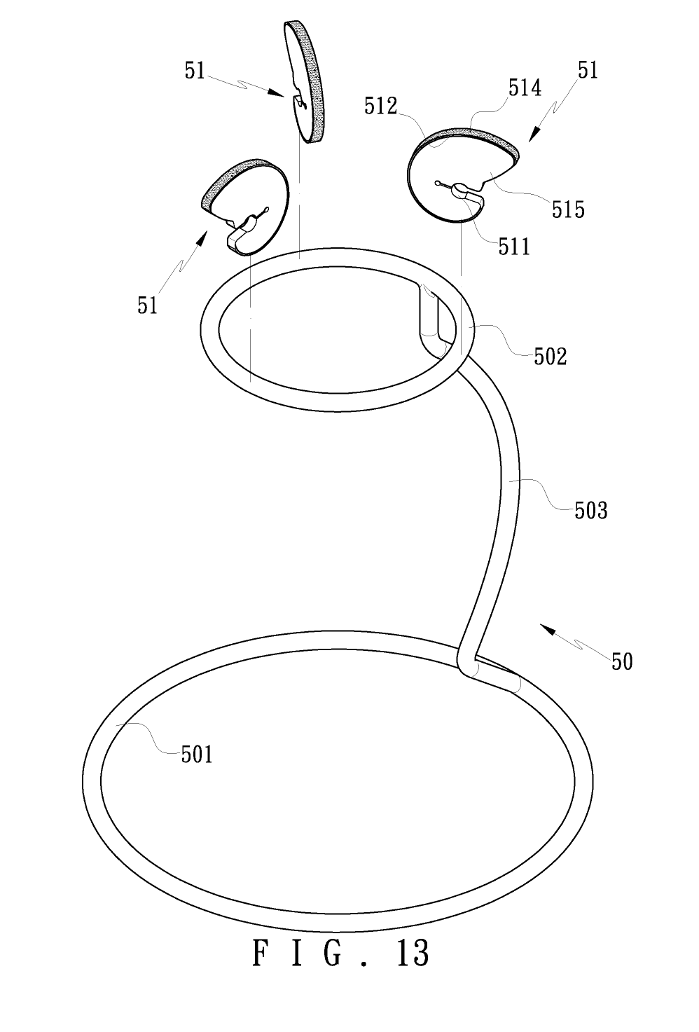

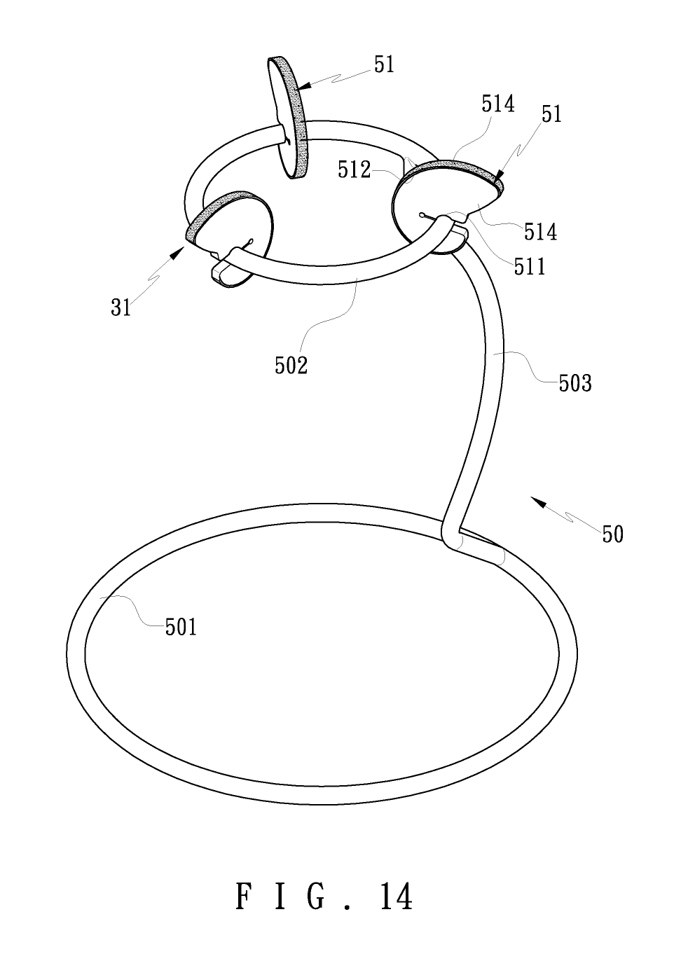

Referring to FIGS. 13 and 14, an adjustable supporting apparatus for an object holder in accordance with a second preferred embodiment of the present invention is illustrated, which comprises a body 50 and a plurality of support elements 51. The body 50 includes a bottom seat 501 disposed on a bottom end thereof, an upper seat 502 mounted on an upper end thereof, and a connecting post 503 connected between the bottom seat 501 and the upper seat 502, wherein the upper seat 502 is formed in a circular ring shape for receiving an object and the support elements 51 are arranged therearound.

An axial rotating structures is defined between one end of each support element 51 and the upper seat 502 so that the support element 51 can be rotated axially. In the second embodiment, the axial rotating structure has an axial rotating portion 511 retained on the upper seat 502 so that the support element 51 is axially rotated along the upper seat 502 by means of the axial rotating portion 511, wherein the axial rotating portion 511 is an open groove with an arcuate surface, wherein the arcuate surface has a flexible gap to be expanded and retracted. Each of the support elements 51 has an abutting tab formed on another end thereof to rotate axially by ways of the axial rotating structure and to abut against the object.

In this second embodiment, each of the support members 51 has a contacting rim 512 disposed therearound to be rotated by means of the axial rotating structure and to hold the object. In this second embodiment, the contacting rim 512 is an arcuate surface formed along the support member 51 to be adjusted to abut against a third holding range according to a shape and a size of the object. In addition, the contacting rim 512 includes an anti-slip member 514 attached thereon to increase friction between the contacting rim 512 and the object, wherein each of the support elements 51 further has a holding projection 515 extending from one side thereof to be held by a user.

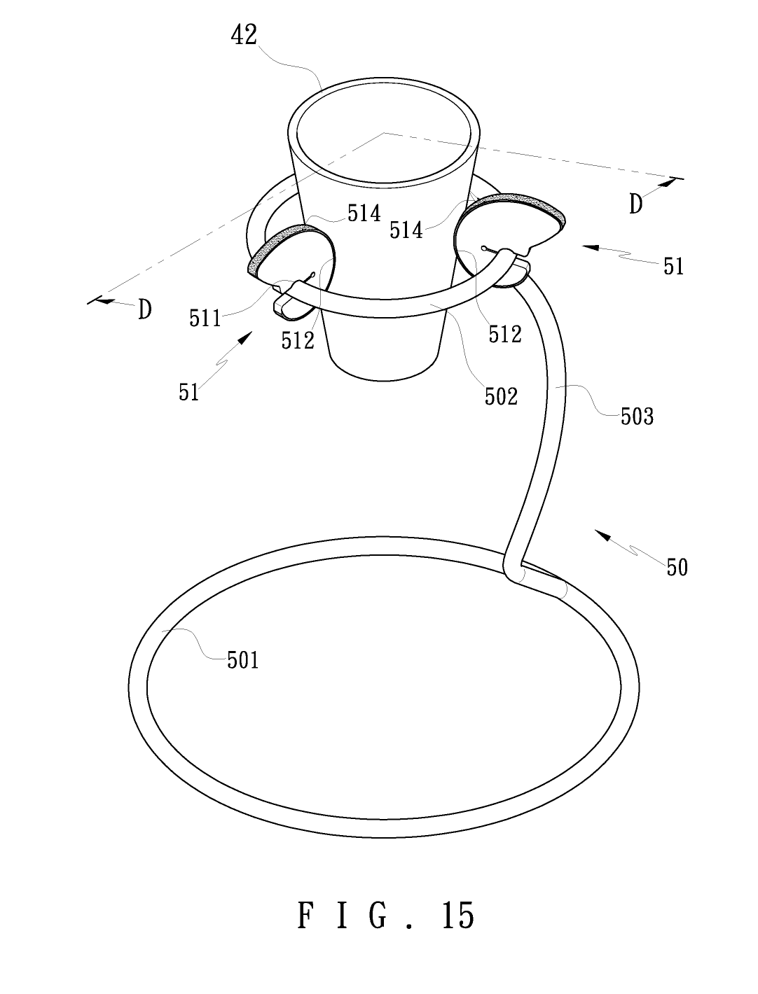

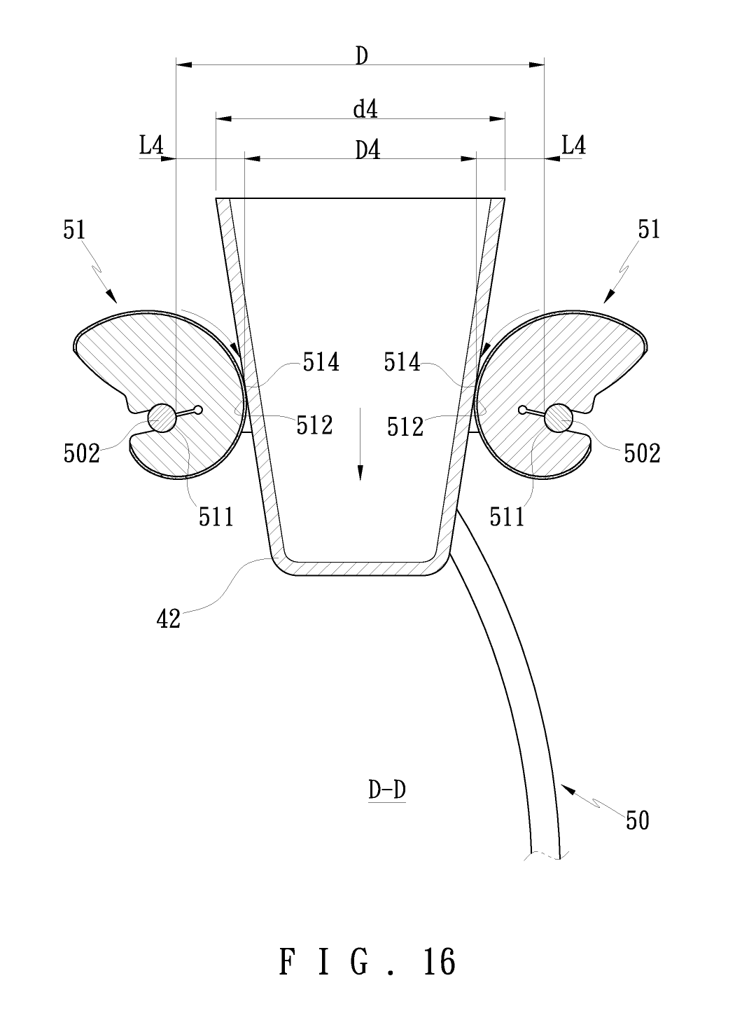

As illustrated in FIGS. 15 and 16, as holding a conical object 42, due to a third largest outer diameter d4 of the conical object 42 is smaller than a first inner diameter D of the upper seat 502 of the body 50, the contacting rims 512 of the support elements 51 are rotated toward the upper seat 502 of the body 50 according to the third largest outer diameter d4 of the conical object 42 so that the contacting rims 512 of the support elements 51 extend a fourth distance L4 toward the upper seat 502 of the body 50 to generate a fourth holding range. A fifth inner diameter D4 of the fourth holding range is smaller than the third largest outer diameter d4 of the conical object 42. Accordingly, the fourth holding range between the contacting rims 512 of the support elements 51 enables the conical object 42 to be held in position. When the contacting rims 512 of the support elements 51 hold the conical object 42, a friction between the anti-slip members 514 and the conical object 42 and a gravity of the conical object 42 are served to guide the contacting rims 512 to form a fourth inward rotating torque toward the upper seat 502. Because the axial rotating portion 511 is limited by the upper seat 502 and the contacting rim 512 is biased against the conical object 42, each of the support elements 51 is not rotated toward the upper seat 502 anymore. In the contrast, the contacting rim 512 generates a horizontal pushing force to support the conical object 42 securely.

Thereby, each of the support elements is capable of being rotated to adjust a desired holding range and height based on the size of the object to enhance its utility for better convenient and decorative purposes.

The invention is not limited to the above embodiment but various modifications thereof may be made. It will be understood by those skilled in the art that various changes in form and detail may made without departing from the scope and spirit of the present invention.

What is claimed is:

1. An adjustable supporting apparatus of an object holder, comprising:
a body including an upper seat mounted on an upper end thereof for receiving the object; and
a plurality of support elements, each having one end axially connected on said upper seat of said body by means of an axial rotating structure and another end having an abutting portion formed thereon to rotate axially by means of said axial rotating structure and to abut against the object.

2. The adjustable supporting apparatus of the object holder as claimed in claim 1, wherein said body includes a bottom seat disposed on a bottom end thereof

3. The adjustable supporting apparatus of the object holder as claimed in claim 1, wherein a connecting post is connected between said bottom seat and said upper seat.

4. The adjustable supporting apparatus of the object holder as claimed in claim 1, wherein said upper seat is formed in a circular ring shape.

5. The adjustable supporting apparatus of the object holder as claimed in claim 1, wherein the axial rotating structure includes an axial rotating portion retained on said upper seat so that each of said support elements is rotated axially along said upper seat by means of said axial rotating portion.

6. The adjustable supporting apparatus of the object holder as claimed in claim 5, wherein said axial rotating portion is an open groove with an arcuate surface, wherein said arcuate surface has a flexible gap to be expanded and retracted.

7. The adjustable supporting apparatus of the object holder as claimed in claim 5, wherein said abutting portion is an arcuate surface formed along said support member.

8. The adjustable supporting apparatus of the object holder as claimed in claim 1, wherein said support member includes a first abutting tab disposed on another end thereof and a second abutting tab located at one side of said first abutting tab.

9. The adjustable supporting apparatus of the object holder as claimed in claim 1, wherein said abutting portion includes an anti-slip member attached thereon for increasing friction between said abutting portion and said object.

10. The adjustable supporting apparatus of the object holder as claimed in claim 1, wherein each of said support elements further has a holding projection extending from one side thereof.
